(19) United States
(12) Patent Application Publication
(10) Pub. No.: US 2016/0012513 A1
(43) Pub. Date: Jan. 14, 2016

(54) SYSTEMS AND METHODS FOR FOOD AND RESTAURANT RECOMMENDATIONS

(71) Applicant: Martinez Management, Inc., Palm Coast, FL (US)

(72) Inventors: Richard J. Martinez, Palm Coast, FL (US); Debra A. Martinez, Palm Coast, FL (US)

(21) Appl. No.: 14/794,527

(22) Filed: Jul. 8, 2015

Related U.S. Application Data
(60) Provisional application No. 62/021,981, filed on Jul. 8, 2014.

(51) Int. Cl. G06Q 30/06; G06Q 50/12

(52) U.S. Cl. CPC G06Q 30/0631; G06Q 50/12

(57) ABSTRACT

A restaurant and food recommendation system includes: a database of user data including user identification and food preference data. The system receives a recommendation request from a user device including the user identification and location data and analyzes a plurality of the food preference data from a plurality of the users to determine a probabilistic relationship between either the restaurant ratings or the menu item ratings of at least two users. Using the probabilistic relationship between either the restaurant ratings or the menu item ratings of at least two users and further filtering based on the data related to the user dietary needs and the data related to cuisine type ratings associated with the requesting user, as well as filtering using the location data received in the recommendation request, the system generates a recommendation related to a restaurant or to a menu item for the requesting user.

### CROSS-REFERENCE TO RELATED APPLICATIONS

This application incorporates by reference and claims the benefit of priority to U.S. Provisional Patent Application No. 62/021,981 filed Jul. 8, 2014.

### BACKGROUND OF THE INVENTION

The present subject matter relates generally to a food recommendation engine. More specifically, the present subject matter relates to a software application adapted to receive input from one or more users and provide specific, personalized recommendations related to restaurants and menu items at those restaurants.

Many people use restaurant reviews to help them plan eating out, either alone or in a group. Typically, people use online restaurant ratings and reviews. Unfortunately, restaurant reviews only tell a fraction of the story as to whether or not one will enjoy a meal at a given restaurant. One problem is that many online reviews are overly positive or negative. For example, reviews provided by someone related to the business owner may be overly positive with the intention to help the restaurant. Similarly, reviews posted by a competitor may be intended to harm a restaurant. These reviews do little to assist a reader in determining whether or not she will enjoy a meal at a given restaurant.

A notable flaw with a large percentage of reviews is review primarily focuses on the tastes of a reviewer, which may be of limited use to the review user. For example, a review may be positive or negative for reasons that don't matter to you. A reviewer may have had a better or worse experience due to the decor of the restaurant, whereas that may be of little or no importance to you. More on point, the reviewer may have tried dishes other than those you would choose or may simply like different foods than the reader would like. In other words, a given review may be made for any number of reasons that do not matter to the reader.

Another problem with typical online reviews is that they are passive and are unable to make recommendations to the user. More difficult is when trying to satisfy the tastes of several diners. There are few, if any, known tools useful for meeting the tastes of multiple people. In most cases, a user seeking a match for a group of people will look for a restaurant with a diverse menu or a popular cuisine. But these may be suboptimal solutions when there may be a restaurant that specifically matches the tastes of each of the diners in the group, but is not known for having a diverse menu or widely popular cuisine.

Separately, there is a need for those that eat out to help facilitate an improved ordering experience at restaurants. Whether dining at a new restaurant or returning to an old favorite, diners would benefit from personalized recommendations for menu items to order at a given restaurant.

Accordingly, there is a need for a personalized food and restaurant recommendation application, as described herein.

### BRIEF SUMMARY OF THE INVENTION

To meet the needs described above and others, the present disclosure provides systems and methods for providing users with personalized recommendations for restaurants and, more specifically, menu items at those restaurants. As described herein, the systems and methods may be embodied in a software application, such as, for example, a mobile application. Alternatively, the application may be a web application or other remotely hosted application.

In a primary embodiment, the subject matter provided herein is a mobile application that assists users in finding appropriate restaurants and making informed selections from the menu. For example, a user may query the application to request a suggestion for eating out. Knowing the user's tastes, based on data saved from the user's interaction with the application, and comparing the user's tastes to information derived from other users' interaction with the application, the application may suggest one or more restaurants, one or more menu items at each restaurant, and even the manner in which to order the menu items (e.g., go to Kuma's Corner, order the Iron Maiden burger, and request they hold the chipotle mayo). In addition, the application may provide coupons related to the recommendation or in competition with the recommendation to further influence the user's decision.

In another example, two or more users may request that the application provide a recommendation for the group. Based on the dining preferences of each member of the group, and factoring in the data derived from other users in the system, the application may suggest one or more restaurants that match the tastes of each member of the group and suggest menu selections for each member of the group, and the manner in which each member should order the menu item. (e.g., go to Spacca Napoli, order the Prosciutto e Bufala as an appetizer to share, Patrick should order the Funghi e Salsiccia pizza and Lora should order the Biana con Rucola).

In a further example, the application may actively make ordering suggestions, even when not actively requested. For example, upon arriving at the restaurant Summer House Santa Monica, which the application knows based on the geolocation of the user's mobile device, the application may provide a push notification to the user to remind the user to order the short rib (the user's favorite menu item at the restaurant) and do not order the lemonade (which the user has ordered twice before, but rated poorly).

In yet another example, additional user information may be collected and stored by the system to facilitate recommendations, warnings, etc. For example, a user may provide information regarding food allergies and sensitivities, which can be used by the system to provide additional user specific guidance. For example, a user that has instructed the system he has a peanut allergy may find himself considering eating at a Five Guys® restaurant. Having previously collected information from other users that the restaurant serves peanuts in bulk containers, the user may proactively receive a warning that the restaurant is an allergy risk.

In order to facilitate the features and functions described herein, the system may include a central server in communication with a plurality of user devices. Each user device runs a mobile application through which each user records reviews of restaurants, including experiences with specific menu items, and manners in which the menu items are ordered. The information is communicated to the server, where it is stored, aggregated, and analyzed using one or more machine learning algorithms, for example, using a Bayesian network, to determine probabilistic relationships between the ratings provided by a user and the ratings of other users. Additional user information is collected and stored by the system to make intelligent recommendations to the user when choosing a restaurant or ordering at a restaurant.

In one example, a restaurant and food recommendation system includes: a database of user data including a user identification for each of a plurality of users and, additionally for each user, food preference data including; data related to user dietary needs; data related to cuisine type ratings; data related to restaurant ratings; and data related to menu item ratings; a controller in communication with the database; and a memory in communication with the controller, the memory including instructions that when executed by the controller cause the controller to perform the steps of: receive a recommendation request from a requesting user through a user device including the user identification and location data; in response to the receipt of the recommendation request, analyzing a plurality of the food preference data from a plurality of the users to determine a probabilistic relationship between either the restaurant ratings or the menu item ratings of at least two users; using the probabilistic relationship between either the restaurant ratings or the menu item ratings of at least two users and further filtering based on the data related to the user dietary needs and the data related to cuisine type ratings associated with the requesting user, as well as filtering using the location data received in the recommendation request, generate a recommendation related to a restaurant or to a menu item for the requesting user; and provide the generated recommendation to the user via the user device.

The system may further include data related to a manner in which to order a menu item and the generated recommendation may further include a menu item and the manner in which to order the menu item.

The recommendation request may further include an identification of a second user and the controller additionally filters based on the data related to the user dietary needs and the data related to cuisine type ratings associated with the second user to generate a recommendation related to a restaurant.

The recommendation request may further include the identification of a second user and the controller additionally filters based on the data related to the user dietary needs and the data related to cuisine type ratings associated with the second user to generate a recommendation related to a menu item for the second user.

In one example, one of the at least two users for the probabilistic relationship between either the restaurant ratings or the menu item ratings is the requesting user.

The generated recommendation may relate to a restaurant and the restaurant may be one for which the database does not include any restaurant ratings data associated with the requesting user. In other words, the restaurant recommended to the user may be a restaurant for which the user has not provided the system with any reviews or ratings.

The generated recommendation may relate to a menu item and the menu item may be one for which the database does not include any restaurant ratings data associated with the requesting user. In other words, the menu item recommended to the user may be a menu item for which the user has not provided the system with any reviews or ratings.

In some embodiments, the user device includes a positioning sensor identifying the location of the user device to the controller and the database includes locations of restaurants and the generated recommendation includes an allergy warning generated in response to the combination of the requesting user's food preference data, data related to allergy information related to restaurants, and the location of the user device. In other words, when the user is in a location where an allergy warning may be relevant, the system may provide such warning. In fact, the allergy warning may be provided automatically in response to the system recognizing the user device is in a restaurant for which the allergy warning is applicable.

In other examples, the user device includes a positioning sensor identifying the location of the user device to the controller and the database includes locations of restaurants, wherein the generated recommendation includes a manner in which to order a menu item generated in response to the combination of the requesting user's food preference data and the location of the use device. The manner in which to order a menu item may be provided automatically in response to the system recognizing the user device is in a restaurant for which the manner in which to order a menu item is applicable.

An object of the invention is to provide users with more specific and relevant restaurant recommendations.

Another object of the invention is to provide specific menu item recommendations for a given restaurant.

A further object of the invention is to provide recommendations for how to order recommended menu items.

An additional object of the invention is to provide a platform through which groups of people can easily identify a restaurant that meets each of their tastes and preferences.

Another object of the invention is to provide a platform that assists users in ordering menu items, including user specific special requests, such as holding or adding ingredients.

An advantage of the invention is that it is an improvement over typical restaurant reviews, which are neither user specific, nor particularly well suited for identifying menu items a user may enjoy.

Another advantage of the invention is that it harnesses the power of machine learning directed to user generated data sets concerning restaurant and menu item reviews and recommendations to provide users a more richly engaging and valuable recommendation.

Additional objects, advantages and novel features of the examples will be set forth in part in the description which follows, and in part will become apparent to those skilled in the art upon examination of the following description and the accompanying drawings or may be learned by production or operation of the examples. The objects and advantages of the concepts may be realized and attained by means of the methodologies, instrumentalities and combinations particularly pointed out in the appended claims.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 is a schematic representation of a system embodying the features and functions described herein.

FIG. 2 is a schematic representation of a mobile device used in the system illustrated in FIG. 1.

FIG. 3 is a representation of a user interface embodying a settings control panel screen.

FIG. 4 is a representation of a user interface embodying a menu item rating collection screen.

FIG. 5 is a representation of a user interface embodying a restaurant suggestion screen.

FIG. 6 is a representation of a user interface embodying a menu item recommendation screen.

FIG. 7 is a representation of a user interface embodying a map screen.

FIG. 8 is a representation of a user interface embodying a restaurant menu.

FIG. 9 is a representation of a user interface embodying a push notification providing an order recommendation.

FIG. 10 is a representation of a user interface embodying a push notification providing an allergy warning.

### DETAILED DESCRIPTION OF THE INVENTION

The present disclosure provides systems and methods for providing users with personalized recommendations/suggestions for: restaurants; menu items at restaurants; how to order the menu items; as well as allergy warnings and the like. As described herein, the systems and methods may be embodied in a software application, such as a mobile application, a web application, or other remotely hosted application.

The systems and methods described herein assist users in finding appropriate restaurants and making informed selections from the menu at those restaurants. Based on data related to the user's tastes, based on data saved from the user's interaction with the application, and comparing the user's tastes to information derived from other users' interaction with the application, the application may suggest one or more restaurants, one or more menu items at each restaurant, and even the manner in which to order the menu items.

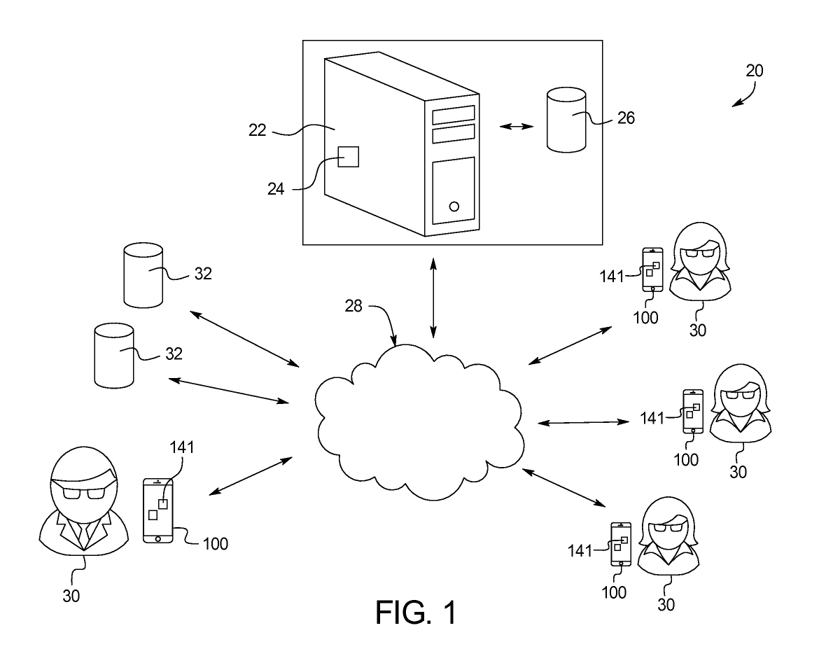

FIG. 1 illustrates an example of a restaurant and food recommendation system 20 (“system 20”) embodying the features and functions described herein. As shown in FIG. 1, the system 20 includes a controller 22 in communication with memory 24 and further in communication with a database 26. The controller 22 communicates with the other components of the system 20 though a network 28, such as the Internet.

As further shown in FIG. 1, a plurality of users 30 interact with the system 20 through a mobile device application 141 provided though user devices 100. Lastly, FIG. 1 shows additional datasets 32 accessible by the controller 22 through the network 28. For example, the additional datasets 32 may include restaurant menus, maps, and additional information that inform the functions described further herein.

The controller 22 may be a central control processing system utilizing a central processing unit (CPU), memory 24, and an interconnect bus. The CPU may contain a single microprocessor, or it may contain a plurality of microprocessors for configuring the CPU as a multi-processor system. The memory 24 may include various types of memory 24 including a main memory, such as a dynamic random access memory (DRAM) and cache, as well as a read only memory, such as a PROM, EPROM, FLASH-EPROM, or the like. The memory 24 may include any form of volatile or non-volatile memory. In operation, the main memory stores at least portions of instructions for execution by the CPU and data for processing in accord with the executed instructions. The controller 22 also includes one or more input/output interfaces to enable communications via the network 28 and to the database 26.

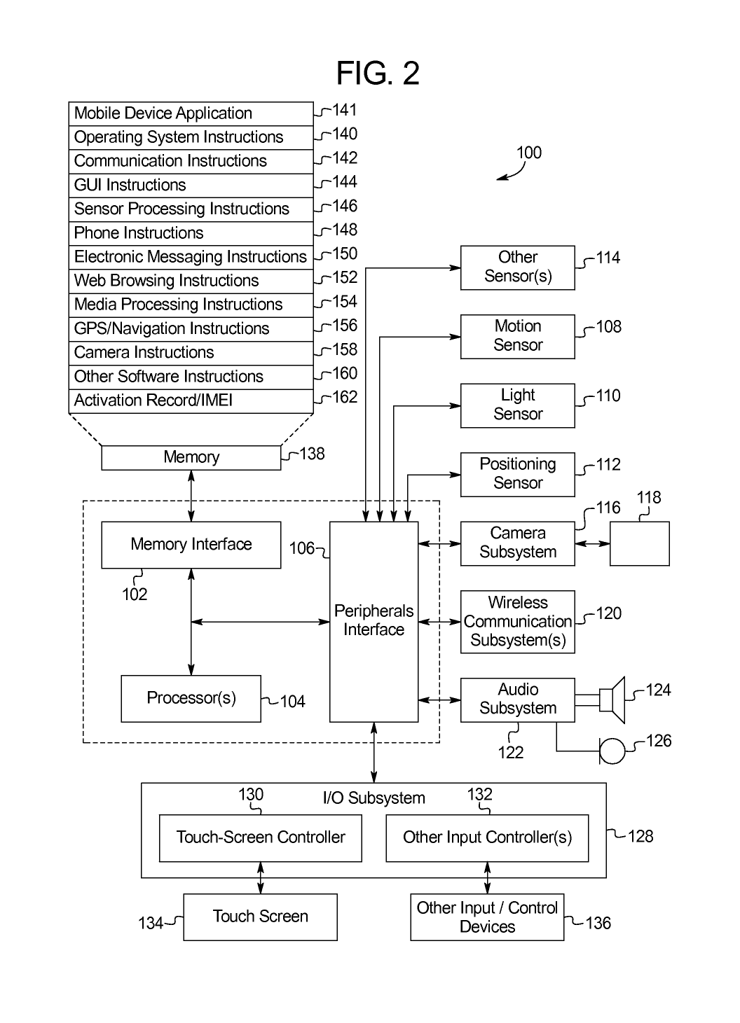

FIG. 2 illustrates a block diagram representation of an example of a user device 100. As shown in FIG. 2, the user device 100 includes a mobile device application 141 installed in the memory 138 of the user devices 100. The mobile device application 141 performs the features and functions described herein. The user devices 100 may be a mobile device 100 such as an iOS®, Android®, Windows®, or other commercially available or special purpose mobile device 100.

Referring back to FIG. 2, the user device 100 includes a memory interface 102, one or more data controllers, image controllers and/or central controllers 104, and a peripherals interface 106. The memory interface 102, the one or more controllers 104 and/or the peripherals interface 106 can be separate components or can be integrated in one or more integrated circuits. The various components in the user device 100 can be coupled by one or more communication buses or signal lines, as will be recognized by those skilled in the art.

Sensors, devices, and additional subsystems can be coupled to the peripherals interface 106 to facilitate various functionalities. For example, a motion sensor 108 (e.g., a gyroscope), a light sensor 110, and a positioning sensor 112 (e.g., GPS receiver) can be coupled to the peripherals interface 106 to facilitate any orientation, lighting, and positioning functions described further herein. Other sensors 114 can also be connected to the peripherals interface 106, such as a proximity sensor, a temperature sensor, a biometric sensor, or other sensing device, to facilitate related functionalities.

A camera subsystem 116 and an optical sensor 118 (e.g., a charged coupled device (CCD) or a complementary metal-oxide semiconductor (CMOS) optical sensor) can be utilized to facilitate camera functions, such as recording photographs and video clips.

Communication functions can be facilitated through one or more wireless communication subsystems 120, which can include radio frequency receivers and transmitters and/or optical (e.g., infrared) receivers and transmitters. The specific design and implementation of the communication subsystem 120 can depend on the communication network(s) over which the user device 100 is intended to operate. For example, the user device 100 can include communication subsystems 120 designed to operate over a GSM network, a GPRS network, an EDGE network, a Wi-Fi or WiMax network, and a Bluetooth network. In particular, the wireless communication subsystems 120 may include hosting protocols such that the user device 100 may be configured as a base station for other wireless devices.

An audio subsystem 122 can be coupled to a speaker 124 and a microphone 126 to facilitate voice-enabled functions, such as voice recognition, voice replication, digital recording, and telephony functions.

The I/O subsystem 128 can include a touch screen controller 130 and/or other input controller(s) 132. The touch screen controller 130 can be coupled to a user interface 134, such as a touch screen. The user interface 134 and touch screen controller 130 can, for example, detect contact and movement, or break thereof, using any of a plurality of touch sensitivity technologies, including but not limited to capacitive, resistive, infrared, and surface acoustic wave technologies, as well as other proximity sensor arrays or other elements for determining one or more points of contact with the touch screen 134. The other input controller(s) 132 can be coupled to other input/control devices 136, such as one or more buttons, rocker switches, thumb-wheel, infrared port, USB port, and/or a pointer device such as a stylus. The one or more buttons (not shown) can include an up/down button for volume control of the speaker 124 and/or the microphone 126.

The memory interface 102 can be coupled to memory 138. The memory 138 can include high-speed random access memory and/or non-volatile memory, such as one or more magnetic disk storage devices, one or more optical storage devices, and/or flash memory (e.g., NAND, NOR). The memory 138 can store operating system instructions 140, such as Darwin, RTXC, LINUX, UNIX, OS X, iOS, ANDROID, BLACKBERRY OS, BLACKBERRY 10, WINDOWS, or an embedded operating system such as VxWorks. The operating system instructions 140 may include instructions for handling basic system services and for performing hardware dependent tasks. In some implementations, the operating system instructions 140 can be a kernel (e.g., UNIX kernel).

The memory 138 may also store communication instructions 142 to facilitate communicating with one or more additional devices, one or more computers and/or one or more servers. The memory 138 may include graphical user interface instructions 144 to facilitate graphic user interface processing; sensor processing instructions 146 to facilitate sensor-related processing and functions; phone instructions 148 to facilitate phone-related processes and functions; electronic messaging instructions 150 to facilitate electronic-messaging related processes and functions; web browsing instructions 152 to facilitate web browsing-related processes and functions; media processing instructions 154 to facilitate media processing-related processes and functions; GPS/Navigation instructions 156 to facilitate GPS and navigation-related processes and instructions; camera instructions 158 to facilitate camera-related processes and functions; and/or other software instructions 160 to facilitate other processes and functions (e.g., access control management functions, etc.). The memory 138 may also store other software instructions controlling other processes and functions of the user device 100 as will be recognized by those skilled in the art. In some implementations, the media processing instructions 154 are divided into audio processing instructions and video processing instructions to facilitate audio processing-related processes and functions and video processing-related processes and functions, respectively. An activation record and International Mobile Equipment Identity (IMEI) 162 or similar hardware identifier can also be stored in memory 138.

Each of the above identified instructions and applications can correspond to a set of instructions for performing one or more functions described herein. These instructions need not be implemented as separate software programs, procedures, or modules. The memory 138 can include additional instructions or fewer instructions. Furthermore, various functions of the user device 100 may be implemented in hardware and/or in software, including in one or more signal processing and/or application specific integrated circuits. Accordingly, the user device 100, as shown in FIG. 2, may be adapted to perform any combination of the functionality described herein.

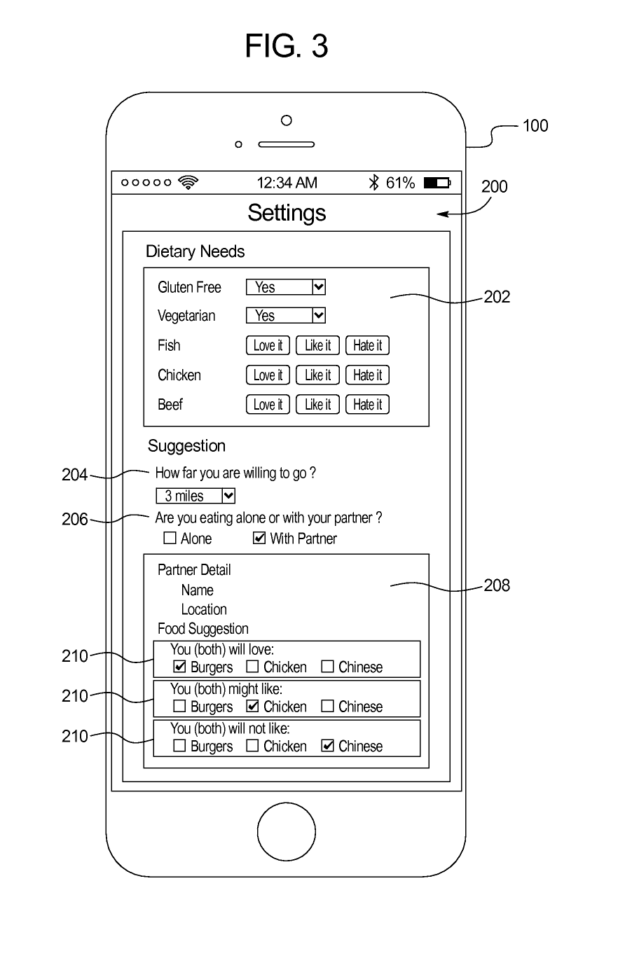

The users 30, through the system 20 shown in FIG. 1 and the user device 100 shown in FIG. 2, access the mobile device application 141. The mobile device application 141 is the mechanism through which the features and functions are delivered to the users 30. The descriptions of FIGS. 3-10 that follow help illustrate the user interaction with the system 20 through the user device 100.

As described, the system 20 may assist a user 30 in finding appropriate restaurants and making informed selections from the restaurant's menu. For example, a user 30 may query the mobile device application 141 to request a suggestion for eating out. Knowing the user's tastes, based on data saved from the user's interaction with the mobile device application 141, and comparing the user's tastes to information derived from other users' interaction with the mobile device application 141, the mobile device application 141 may suggest one or more restaurants, one or more menu items at each restaurant, and even the manner in which to order the menu items. To facilitate these interactions, a user 30 may provide details to the system 20 through a settings screen 200 provided by the mobile device application 141, as shown in FIG. 3.

The settings screen 200 shown in FIG. 3 is merely one example of a settings screen 200 that may be employed in the system 20. It is believed that the simplified embodiment shown in FIG. 3 is appropriate for teaching the manner in which a settings screen 200 may be implemented, but is not intended to represent the full breath of settings controls that will be appreciated by those skilled in the art based on the descriptions provided herein.

In the example shown, the settings screen 200 includes a “Dietary Needs” section 202 through which a user 30 may input information defining the user's dietary needs, such as, for example, whether the user 30 is gluten free, a vegetarian, has specific food allergies, has religious restrictions, etc. The user 30 may further input information concerning the user's tastes, such as defining how much or little the user 30 likes a given food type, whether on a sliding scale, a numeric scale, or, as shown in FIG. 3, by selecting whether the user 30 loves, likes, or hates each presented food type. Additional detail may be provided to indicate whether a user 30 has specific preferences for ordering food, e.g., no mayo, low-sodium, etc. These preferences may further influence the recommendations discussed below.

As further shown, the settings screen 200 may also include a distance setting 204 indicating a radius within which restaurant suggestions should be made. This distance may be determined from the present location of the user device 100 (e.g., based on the output of the positioning sensor 112), from stored user information (e.g., home address), or from a manually entered location.

As also shown, the setting screen 200 may request the user 30 to provide whether the user 30 is dining alone or with others via a group dining selection mechanism 206. In the example shown in FIG. 3, the group dining choices are whether the user 30 is dining alone or with a partner. If the user 30 selects to dine with a partner, the user 30 provides the partner name and location that is displayed in the partner detail section 208. In response to the user 30 selecting whether eating alone or with a partner, the system 20 provides its recommendations 210. In the example shown, the recommendations 210 are a list of cuisine types that the partners will love (both love burgers), like (both like chicken), and not like (neither likes Chinese). Of course, the recommendations 210 may be specific restaurants, dishes at the restaurants, etc.

Of particular value to the users 30, the recommendation 210 provided by the system 20 may be adapted to provide a suggested restaurant for a defined group of users 30 and the dishes at the suggested restaurant that each user 30 in the group is likely to enjoy. This may help lower the risk for groups of users 30 wanting to try new restaurants and help groups of users 30 make decisions where each user 30 is comfortable with the selection.

In addition, the recommendations 210 may be accompanied by one or more related coupons. In some examples, the coupons may be for the recommended restaurant. In other examples, the coupons may be for the recommended or a complimentary menu item at the recommended restaurant. In other examples, the one or more coupons may be for competing restaurants.

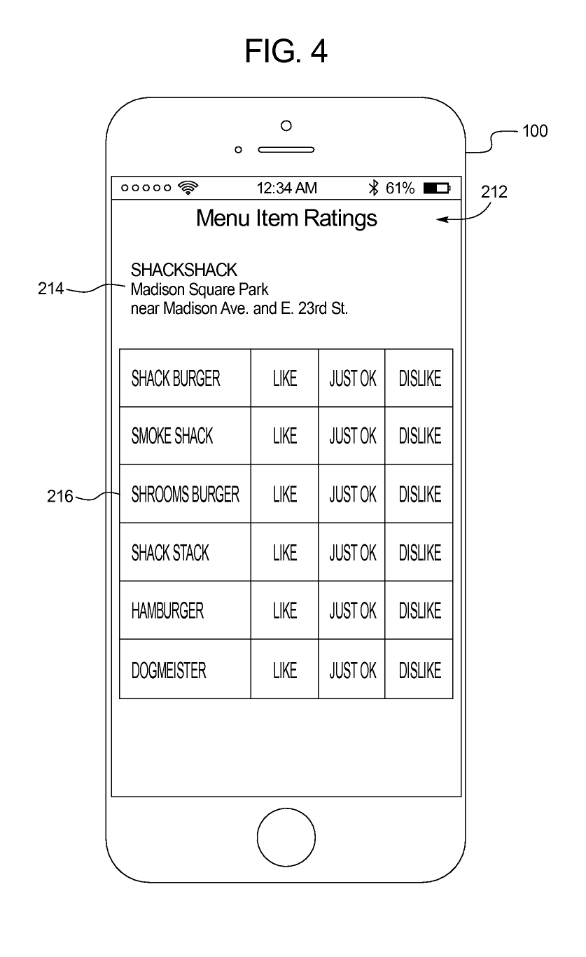

In order to collect the information needed to make recommendations, the system 20 collects information about the user's preferences. In the example shown in FIG. 4, the mobile device application 141 collects menu item ratings for a given restaurant via a menu items rating screen 212. The menu items rating screen 212 displays the restaurant name and address 222 and the menu items from the restaurant. 224 The menu items from the restaurant 224 may be derived from the additional data sets 32 accessible by the controller 22 and the user devices 100 through the network 28. The additional data sets 32 may be provided by the restaurants directly, by third-party service providers, or may be crowd sourced.

For each menu item, the menu item rating screen 212 requests the user's rating 216. For example, the user 30 may identify a rating 216 by selecting either “Like,” “Just OK,” or “Dislike.” Many alternative rating 216 may be used, whether sliding scales, numerical rankings, icons (e.g., smilies, thumbs up, etc.), or other rating mechanisms. Additional granularity in the ratings 216 may translate into more nuanced recommendations 210. For example, the rating 216 may include collecting information about the manner in which the menu item was ordered, e.g., Shack Burger, tomato, lettuce, and pickles only.

Collecting such information through the ratings 216 enable for more complex functionality as described herein.

The more ratings 216 entered by a user 30, the more accurate the recommendations 210 may be. In addition, the system 20 may collect information from other users 30 and use patterns derived from that additional information to improve the recommendations 210. For example, by compiling user data from a number of users 30 in the database 26 and applying one or more machine learning algorithms to the user data, the system 20 may be able to recognize probabilistic relationships between the ratings 216 provided by a user 30 and the ratings 216 of other users 30 such that the system 20 may make predictions as to what a given user 30 will like with respect to restaurants and menu items. This enables the system 20 to make intelligent recommendations for a restaurant or menu item, and even the manner in which to order a menu item without the user 30 having provided any ratings 216 directly related to the restaurant, menu item, or manner in which to order the menu item.

In a simple example, the system 20, through its analysis of the ratings 216 stored in the database 26 for a large number of users 30, may make an intelligent recommendation 210 to a first user 30 that the user 30 will love a specific restaurant based on a number of well-correlated ratings 216 between other users 30 loving that specific restaurant and those other user's 30 ratings 216 for restaurants the first user 30 has rated. In a more complex example, the system 20, through its analysis of the ratings 216 stored in the database 26 for a large number of users, may be able to make an intelligent recommendation 210 to a first user regarding a menu item to order at a restaurant and the manner in which to order it (e.g, preparation technique, substitution, etc.) based on a number of well-correlated ratings 216 between other users 30 ratings for 216 that specific menu item (and manner of ordering) and those other user's 30 ratings 216 for menu items and manners of ordering the first user 30 has rated.

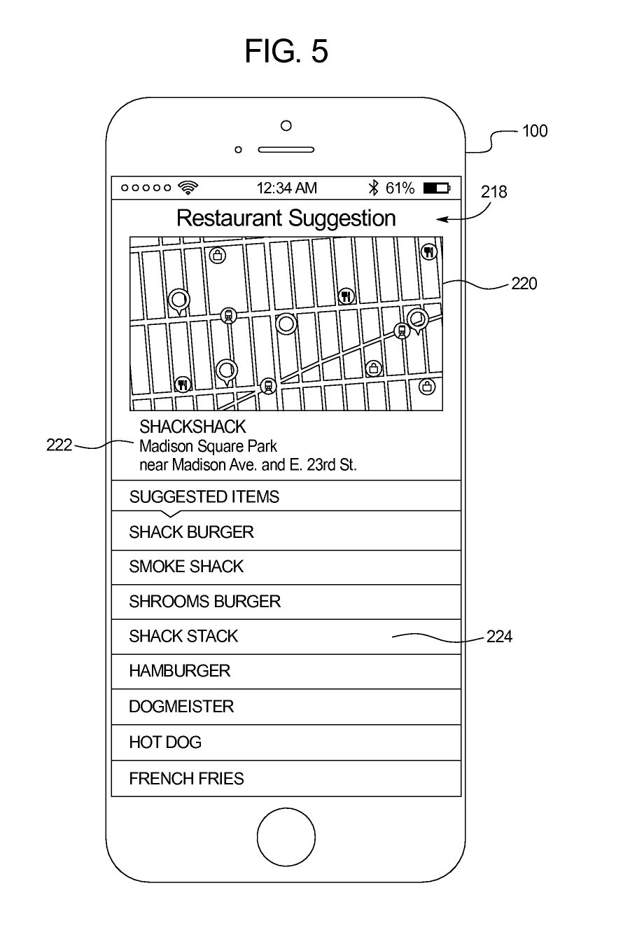

Turning to FIG. 5, a restaurant suggestion screen 218 includes a map 220 with location markers showing the locations of the recommended restaurants. The restaurant suggestion screen 218 further includes the restaurant name and address 222 and an expandable menu 224 that provides all of the details a user 30 may wish to know about a restaurant that has been suggested to the user 30. The restaurant suggestion screen 218 shown in FIG. 5 is an example of an output that may come from the recommendations 210 discussed with reference to FIG. 3.

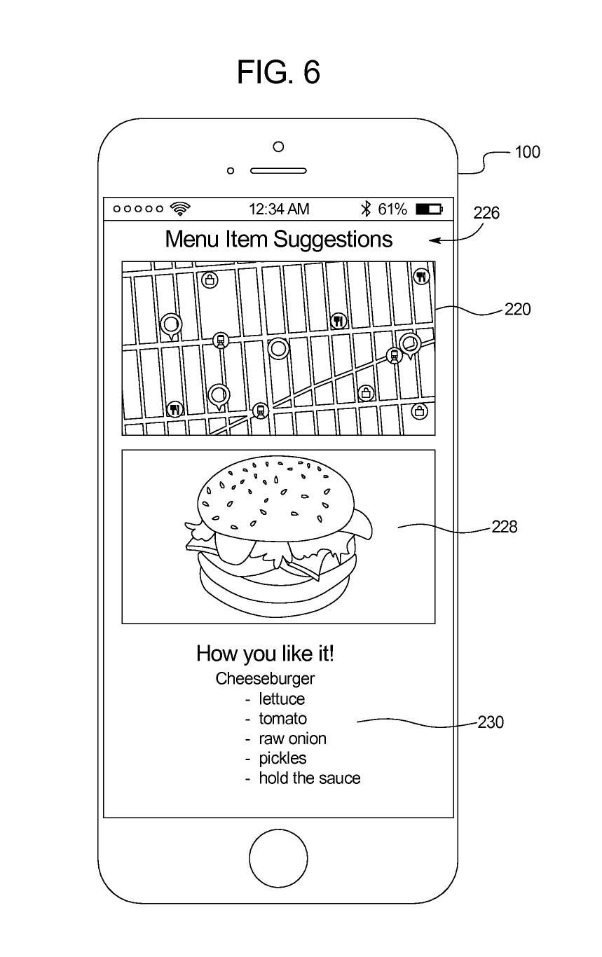

Similarly, the menu item suggestion screen 226 shown in FIG. 6 also includes a map 220 with location markers showing the locations of the recommended restaurants. The example of the menu item suggestion screen 226 shown also includes a photo 228 of the recommended menu item. In the example shown, the menu item suggestion screen 226 further includes a “How You Like It!” section 230 (i.e., order detail section 230) in which the manner in which the user will want to order the menu item is detailed. In this example, the suggested menu item is a cheeseburger and the “How You Like It!” section 230 instructs the user 30 to order the cheeseburger with lettuce, tomato, raw onion, pickles, and to hold the sauce. The menu item suggestion screen 226 shown in FIG. 6 is another example of an output that may come from the recommendations 210 discussed with reference to FIG. 3.

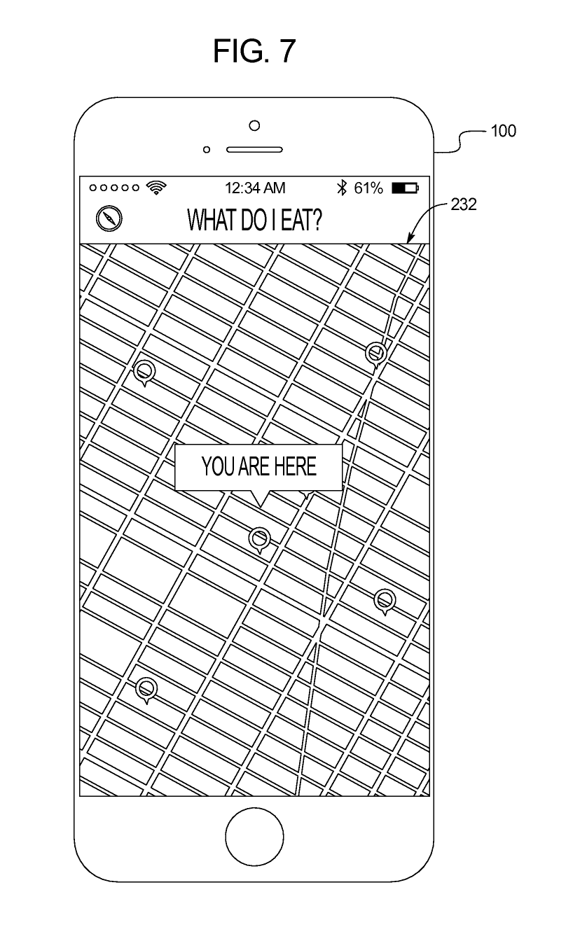

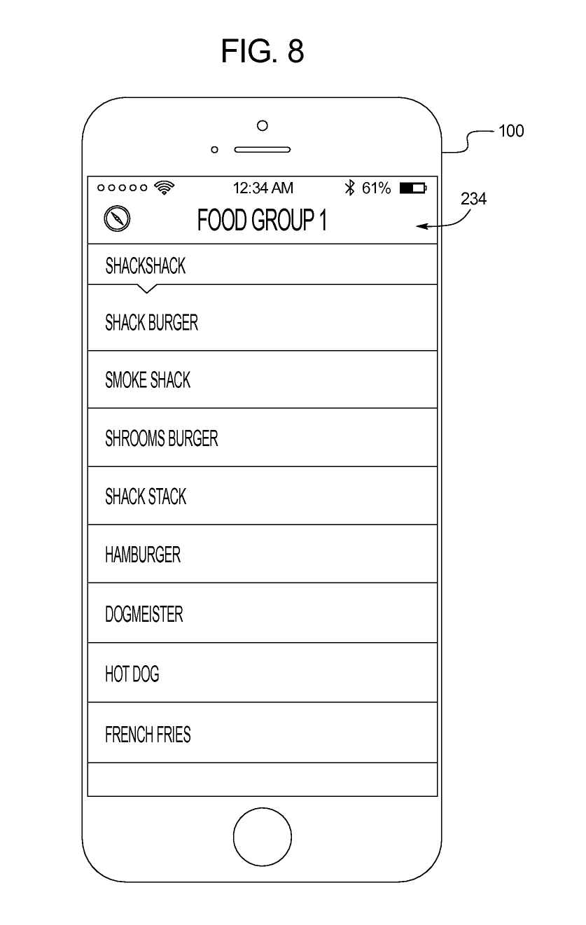

Turning now to FIG. 7, the mobile device application 141 may further provide a map screen 232 that enables a user 30 to search for restaurants by location. The map screen 232 may be an extension of the map 220 described with respect to FIGS. 5 and 6 or may be provided independently. FIG. 8 is an example of a restaurant menu screen 234. As shown, the restaurant is detailed, beneath which menu items are provided. The restaurant menu screen 234 may enable the user 30 to explore restaurant offerings in response to or in parallel with the recommendations 210.

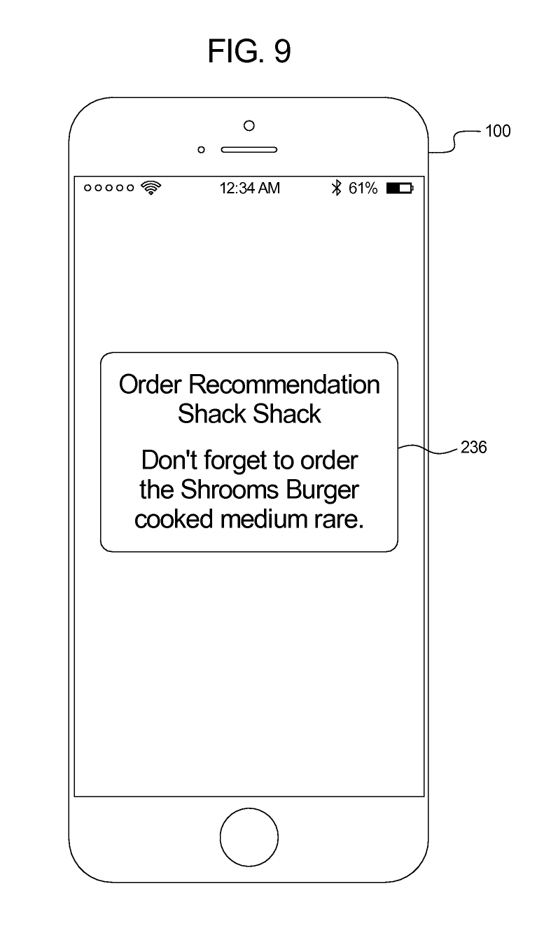

FIG. 9 is an example of a push notification providing an order recommendation 236. In the order recommendation 236, the user 30 is prompted to order the recommended menu item with specific parameters. In this case, the order recommendation 236 instructs the user 30 to order a Shroom Burger cooked medium rare. The order recommendation 236 may be in response to the mobile device application 141 identifying the user 30 is at the restaurant using the positioning sensor 112, as a supplement to the recommendations 210, or in other automated manners.

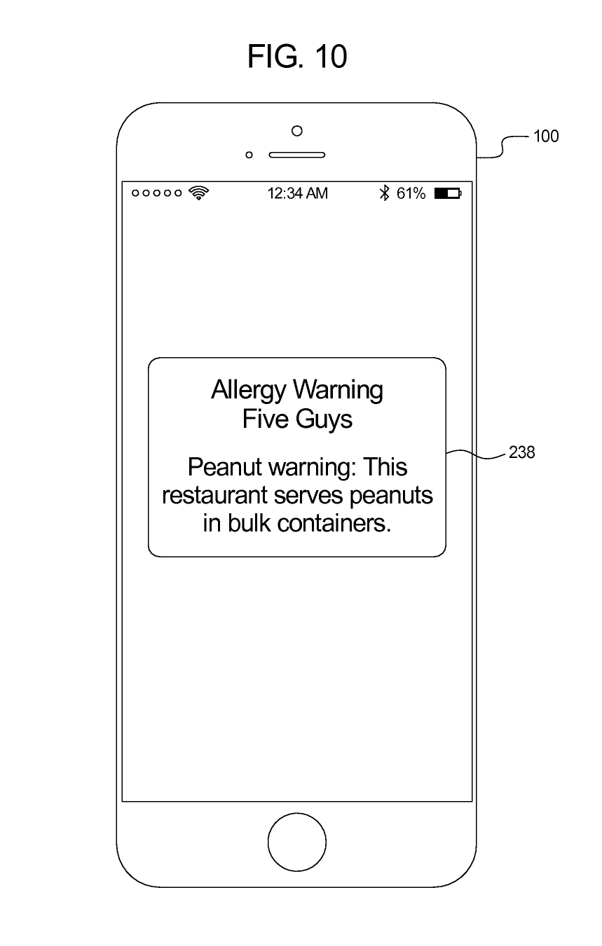

Similarly, FIG. 10 is an example of a push notification providing an allergy warning 238. In the allergy warning 238, the user 30 is prompted with information relevant to his or her allergy. In this case, the allergy warning 238 instructs the user 30 of a potential peanut allergy issue. The allergy warning 238 may be in response to the mobile device application 141 identifying the user 30 is at the restaurant using the positioning sensor 112, as a supplement to the recommendations 210, or in other automated manners.

Aspects of the systems 20 and methods provided herein encompass hardware and software for controlling the relevant functions. Software may take the form of code or executable instructions for causing the controller 22, the processor 104, or other programmable equipment to perform the relevant steps, where the code or instructions are carried by or otherwise embodied in a medium readable by the controller 22, the processor 104 or other machine. Instructions or code for implementing such operations may be in the form of computer instruction in any form (e.g., source code, object code, interpreted code, etc.) stored in or carried by any tangible readable medium.

As used herein, terms such as computer or machine “readable medium” refer to any medium that participates in providing instructions to a controller for execution. Such a medium may take many forms. Non-volatile storage media include, for example, optical or magnetic disks, such as any of the storage devices in any computer(s) shown in the drawings. Volatile storage media include dynamic memory, such as main memory of such a computer platform. Forms of computer-readable media therefore include for example: a floppy disk, a flexible disk, hard disk, magnetic tape, any other magnetic medium, a CD-ROM, DVD, any other optical medium, punch cards paper tape, any other physical medium with patterns of holes, a RAM, a PROM and EPROM, a FLASH-EPROM, any other memory chip or cartridge, or any other medium from which a computer can read programming code and/or data. Many of these forms of computer readable media may be involved in carrying one or more sequences of one or more instructions to a processor for execution.

It should be noted that various changes and modifications to the presently preferred embodiments described herein will be apparent to those skilled in the art. Such changes and modifications may be made without departing from the spirit and scope of the present invention and without diminishing its attendant advantages.

1. A restaurant and food recommendation system comprising:
a database of user data including a user identification for each of a plurality of users and, additionally for each user, food preference data including;
data related to user dietary needs;
data related to cuisine type ratings;
data related to restaurant ratings; and
data related to menu item ratings;
a controller in communication with the database; and
a memory in communication with the controller, the memory including instructions that when executed by the controller cause the controller to perform the steps of:
receive a recommendation request from a requesting user through a user device including the user identification and location data;
in response to the receipt of the recommendation request, analyzing a plurality of the food preference data from a plurality of the users to determine a probabilistic relationship between either the restaurant ratings or the menu item ratings of at least two users;
using the probabilistic relationship between either the restaurant ratings or the menu item ratings of at least two users and further filtering based on the data related to the user dietary needs and the data related to cuisine type ratings associated with the requesting user, as well as filtering using the location data received in the recommendation request, generate a recommendation related to a restaurant or to a menu item for the requesting user; and
provide the generated recommendation to the user via the user device.

2. The system of claim 1 wherein the further includes data related to a manner in which to order a menu item and the generated recommendation further includes a menu item and the manner in which to order the menu item.

3. The system of claim 1 wherein the recommendation request further includes an identification of a second user and the controller additionally filters based on the data related to the user dietary needs and the data related to cuisine type ratings associated with the second user to generate a recommendation related to a restaurant.

4. The system of claim 1 wherein the recommendation request further includes the identification of a second user and the controller additionally filters based on the data related to the user dietary needs and the data related to cuisine type ratings associated with the second user to generate a recommendation related to a menu item for the second user.

5. The system of claim 1 wherein one of the at least two users for the probabilistic relationship between either the restaurant ratings or the menu item ratings of at least two users is the requesting user.

6. The system of claim 1 wherein the generated recommendation relates to a restaurant and the restaurant is one for which the database does not include any restaurant ratings data associated with the requesting user.

7. The system of claim 1 wherein the generated recommendation relates to a menu item and the menu item is one for which the database does not include any restaurant ratings data associated with the requesting user.

8. The system of claim 1 wherein the user device includes a positioning sensor identifying the location of the user device to the controller and the database includes locations of restaurants, wherein the generated recommendation includes an allergy warning generated in response to the combination of the requesting user's food preference data, data related to allergy information related to restaurants, and the location of the user device.

9. The system of claim 8 wherein the recommendation request from the requesting user is automatically provided to the controller by the user device in response to a matching of the location of the user device to the data related to the locations of restaurants.

10. The system of claim 1 wherein the user device includes a positioning sensor identifying the location of the user device to the controller and the database includes locations of restaurants, wherein the generated recommendation includes a manner in which to order a menu item generated in response to the combination of the requesting user's food preference data and the location of the use device.

11. The system of claim 10 wherein the recommendation request from the requesting user is automatically provided to the controller by the user device in response to a matching of the location of the user device to the data related to the locations of restaurants.
